(19) United States
(12) Patent Application Publication
(10) Pub. No.: US 2013/0066591 A1
(43) Pub. Date: Mar. 14, 2013

(54) PERSONAL ELECTRONIC DEVICE TO ASSIST A USER IN DEVELOPING AND MAINTAINING AN OPTIMAL FITNESS WALKING ROUTINE

(71) Applicant: Daniel Kinsbourne, Ridgefield, CT (US)

(72) Inventor: Daniel Kinsbourne, Ridgefield, CT (US)

(21) Appl. No.: 13/230,465

(22) Filed: Sep. 12, 2011

(51) Int. Cl. G01C 22/00

(52) U.S. Cl. 702/160

(57) ABSTRACT

A portable personal electronic pedometer, including a display, a storage memory, an input-mode, a pace-mode, and a workout-mode.

The input mode allows a user to enter personal information including at least the user's weight and either the user's height or stride-length, which is saved in the pedometer's storage memory.

The pace-mode activates the pedometer and employs at least one algorithm to record the average pace and the pedometer's storage memory can concurrently store at least two average pace calculations on the pedometer.

The workout-mode allows the user to select any average target pace stored in the storage memory, and said workout-mode employs at least one algorithm to calculate and display the duration of the workout based on the user's selected target pace and the user's weight, and while in work-out mode the pedometer continually updates the display showing the time remaining, and the pace of the current workout.

### FIELD OF THE INVENTION

The present invention relates to a programmable electronic pedometer designed to assist a user in developing and adhering to a customized “mixed-pace” walking regiment. “Mixed-paced” walking regiments alternate between moderate and faster-paced walking workouts, and have been found to increase fat loss when compared to “fixed-paced” regiment where a similar speed is used for all workouts.

### BACKGROUND OF THE INVENTION

Over 100 Million people use walking exercises in their fitness regiments, and electronic devices such as pedometers and heart-rate monitors are often used by walkers in order to monitor their progress and the efficacy of their exercise routine. However, such devices, though allowing users to monitor their progress, do not actively assist users in developing an effective exercise routine customized to their needs.

A recent study has shown that one method to increase the efficacy of a walking exercise routine is to employ a mixed-pace walking regiment where the user will do faster-paced, shorter walks on one day, and moderate-paced, longer walks on another day. (Irving, Brian A.; Davis, Christopher K.; Brock, David W.; Weltman, Judy Y.; Swift, Damon; Barrett, Eugene J.; Gaesser, Glenn A.; Weltman A. (November, 2008). “Effect of Exercise Training Intensity on Abdominal Visceral Fat and Body Composition.” Medicine & Science in Sports & Exercise 40(11), 1863-1872.)

This same study demonstrated that, on average, by varying the walking pace on alternating workouts, users were able to burn significantly more fat then they could have burned by using a similar fixed-pace in all of their workouts.

Pedometers help users monitor their progress, however they do not actively assist users in developing and maintaining a routine, unlike the present invention which will use various input paramaters to design a mixed-pace walking regiment customized to each user. The device will use the user input to set optimal time, distance, and/or step totals for each workout. Throughout the workout the device will track the user's progress towards the optimal goals, and the display will monitor such progress in order to assist the user in maintaining the appropriate pace during each workout.

### SUMMARY OF THE INVENTION

According to the present invention, a programmable electronic device, uses several input parameters defined by the user in order to generate an optimal walking routine. During the walking routines, the device will constantly monitor the user's progress and adherence to the optimal target ranges for the user's pace, distance and/or steps traveled.

Initially, users will input their weight, height, and stride-length (which could alternatively be calculated by the device based on the user's height). The device will then use this information, to assist users in calculating their ideal varying walking paces, such as “fast-pace” and “moderate-pace.” When the user walks the device acts as a pedometer, and uses the inputted stride-length information to calculate the user's walking speed or average pace based on the number of steps taken. During the initial set-up, users can perform several test walks, at varying paces in order to determine their ideal “moderate” and ideal “fast” paces, which can be stored and saved in the device for use in future work-outs.

When the saved information is accessed, users will input which target “pace” they are using, which should be alternated each workout between “fast” and “moderate.” The device will use the stored data to automatically calculate the user's ideal exercise time. In the preferred embodiment, the device uses a fixed algorithm based on the user's weight, stride-length, and pace to calculate the target workout duration, and the total steps and total distance of the workout. The device will then set a countdown timer accordingly, which in the preferred embodiment can alternate displays between any of the above three parameters (time, steps, or distance remaining).

Throughout the workout, the device will continually monitor the user's average pace and distance walked. Accordingly the user can continually confirm that they are maintaining the desired target pace for the duration of the workout.

The device will also function as a traditional pedometer and will have a memory feature which enables the user to store the data and results from prior workouts. By storing the data, the user will know the results of their most recent workouts, including which “pace” was selected for their most recent workout, as well as how well they adhered to and maintained the target pace for that workout.

### BRIEF DESCRIPTION OF THE DRAWINGS

The attached figures and diagrams illustrate the functions and data-flow of the present invention:

FIG. 1 is a flow-diagram of the input-mode of the present invention, that illustrates the method for inputting the user's height, and the two alternate methods for determining and inputting the user's stride-length;

FIG. 2 is a flow-diagram of the pace-mode of the present invention, that illustrates the method for determining and inputting the user's desired “moderate” pace;

FIG. 3 is a flow-diagram of the pace-mode of the present invention, that illustrates the method for determining and inputting the user's desired “fast” pace;

FIG. 4 is a flow-diagram of the workout-mode of the present invention, that illustrates the use of the device for a workout at one of the desired paces;

FIG. 5 is an illustration of one embodiment of the device; and

FIG. 6 is an illustration of the display of one embodiment of the device during a workout.

### DETAILED DESCRIPTION OF THE DRAWINGS

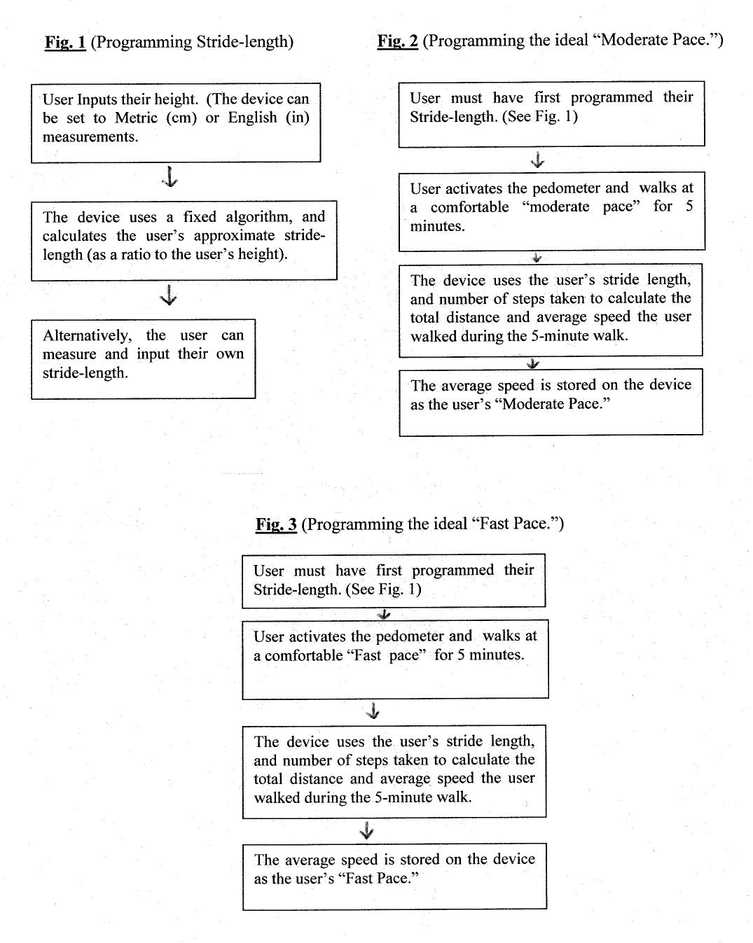

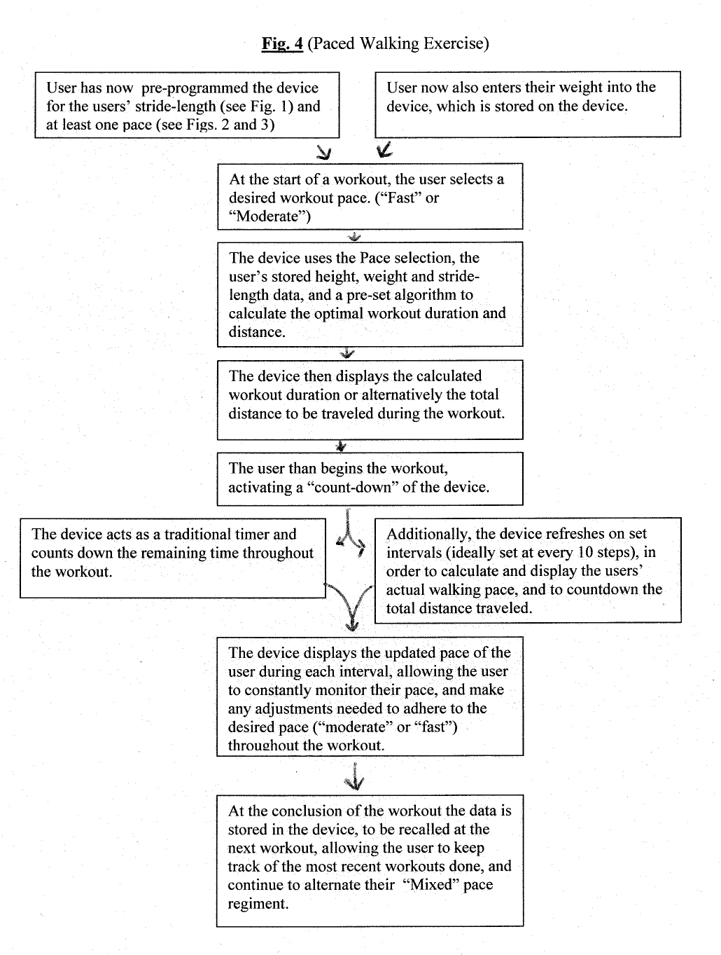

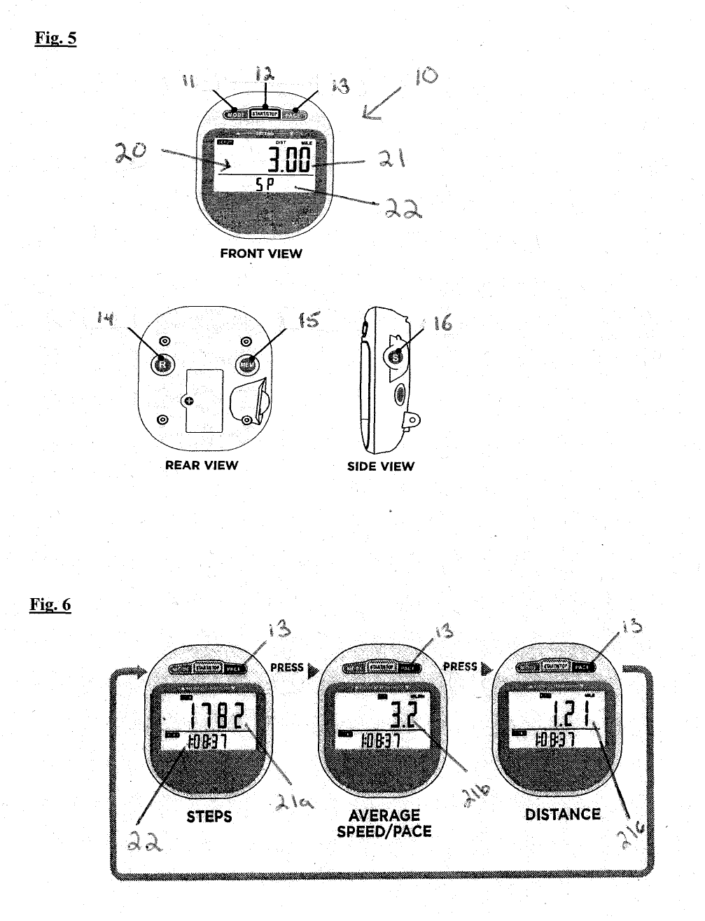

In the input-mode (FIG. 1), the device (10) uses a fixed programmed algorithm to approximate the user's stride-length (average distance per step) based on their sex and height, as shown in FIG. 1. For instance one accepted conversion that can be used is a simple multiplier, where for females, height multiplied by 0.413 equals stride length; and for males, height multiplied by 0.415 equals stride length. Alternatively the user can physically measure and input their own stride-length into the device.

Device (10) has several input and use modes that can be cycled through by activating the “mode” function (11). When inputting data, the device is switched to input mode by activating the “set” function (16). At any point, the display (20) can be reset to allow for a new mode by activating the “reset” function (14).

Device (10) is a traditional pedometer that can employ any known methods for sensing and calculating the number of steps taken by the user. If the user's stride-length is programmed, the pedometer can use a simple multiplier algorithm to determine the total distance traveled by the user based on the number of steps. When combined with a timing function, the device can then use the distance traveled and workout duration to calculate an average speed or “pace.”

As an initial set-up, as shown in FIGS. 2 and 3, a user should activate the pace-mode, and do at least one, but ideally numerous, routine walks using at least two different paces, “moderate” and “fast” in order to create a series of walks at each pace. A routine walk should be approximately 5-minutes, and the user should do a series of such walks at each pace. The device can take the average speed of each series, and determine an ideal target workout pace for “moderate-paced” and “fast-paced” workouts respectively. The more walks done in the initial set-up, the more the calculated pace will accurately reflect the user's personal ideal target walking paces.

Once the ideal respective paces for the individual user have been determined, and stored on the device, the device is ready to be used for workouts, as shown in FIG. 4. As an initial set-up the user must also enter their weight. The user selects their desired target workout pace (“moderate” or “fast”), by using the “pace” function (13). Once the desired pace is selected, the device will use the pace selection, along with the user's weight and stride-length to calculate the workout's ideal totals for: time duration, total steps, and total distance. The user simply activates the start function (12) and begins waking with the selected pace (either moderate or fast).

During the workout, the display screen (20) displays the remaining time (22), and the user's progress (21). The users' progress can be displayed in multiple formats which can be toggled by activating the Pace function (13) during a workout. For instance, in the preferred embodiment progress display (21) can be toggled to show the user's total steps taken (21a), average pace (21b), or total distance (21c). The device updates the progress display (21) frequently throughout the workout allowing the user to constantly monitor their workout and adhere to the desired parameters. In the preferred embodiment, the device updates the data after every 10 steps of the user. This active feedback allows the user to monitor their pace to confirm that they are staying at or near the selected target pace for the duration of the workout.

At the conclusion of any given workout, the user can store the data from the workout simply by activating the memory function (15). In the preferred embodiment, the device will store the previous seven workouts for reference. This allows the user to monitor their progress, and importantly, to know exactly which pace they had used in their previous workouts.

What is claimed is:

1. A portable personal electronic pedometer, including a display, a storage memory, and a workout-mode:
wherein said storage memory stores exactly two target paces, one moderate pace and one fast pace, wherein said fast pace is faster than said moderate pace;
wherein, in said workout-mode, a target pace is selected either by the user or automatically by the pedometer, and said workout-mode employs at least one algorithm to calculate and display the duration of the workout based on the user's selected target pace and the user's weight, and while in work-out mode the pedometer continually updates the display showing the time remaining, and the average pace of the current workout.

2. A portable personal electronic pedometer, including a display, a storage memory, an input-mode, a pace-mode, and a workout-mode:
wherein said input mode allows a user to enter personal information including at least the user's weight and either the user's height or stride-length, and any information entered during the input mode can be saved in the pedometer's storage memory;
wherein said pace-mode activates the pedometer and employs at least one algorithm to record the average pace of the user by multiplying the number of steps taken by the user's stride-length to calculate the total distance traveled, and dividing said total distance by the total duration of the workout in order to obtain an average pace, wherein the pedometer's storage memory can concurrently store at least two average pace calculations on the pedometer; and
wherein said workout-mode allows the user to select any target pace obtained during the pace-mode and stored in the storage memory, and said workout-mode employs at least one algorithm to calculate and display the duration of the workout based on the user's selected target pace and the user's weight, and while in work-out mode the pedometer continually updates the display showing the time remaining, and the pace of the current workout.

2. The portable personal electronic pedometer of claim 2, wherein during workout-mode the pedometer updates the average pace of the entire workout no less frequently than every ten steps of the user during the workout.

3. The portable personal electronic pedometer of claim 2, wherein the display during said work-out mode can be toggled to show the user's target pace selected, and the user's actual pace during the workout.

4. The portable personal electronic pedometer of claim 2, wherein the results of a workout session completed in the workout-mode can be stored in the pedometer's storage memory.

5. The portable personal electronic pedometer of claim 4, wherein, in workout-mode, the pedometer automatically determines the target pace to be used based on the pace used in the prior workouts.

6. The portable personal electronic pedometer of claim 4, wherein said storage memory stores exactly two paces, one moderate pace and one fast pace, wherein said fast pace is faster than said moderate pace.

7. The portable personal electronic pedometer of claim 6, wherein, in workout-mode, the pedometer automatically determines the target pace to be used by alternating between the fast pace and moderate pace respectively for each consecutive workout.
